(19) United States
(12) Patent Application Publication
(10) Pub. No.: US 2026/0316741 A1
(43) Pub. Date: Oct. 15, 2026

(54) CONTROLLING A POWERTRAIN SYSTEM OF A HYBRID VEHICLE

(71) Applicant: JAGUAR LAND ROVER LIMITED, Whitley, Coventry, Warwickshire (GB)

(72) Inventors: Daniel VAQUERIZO SANCHEZ, Whitley, Coventry, Warwickshire (GB); William HARRISON, Whitley, Coventry, Warwickshire (GB); Anders GREGERSEN, Whitley, Coventry, Warwickshire (GB); Olivier ROQUES, Whitley, Coventry, Warwickshire (GB); Romain LACROISILLE, Whitley, Coventry, Warwickshire (GB)

(21) Appl. No.: 19/484,254

(22) PCT Filed: May 2, 2024
(86) PCT No.: PCT/EP2024/062041

§ 371 Date: Nov. 13, 2025

(30) Foreign Application Priority Data
May 17, 2023 (GB) 2307311.7

(51) Int. Cl. B60W 20/13; B60W 10/08; B60W 30/192

(52) U.S. Cl. CPC B60W 20/13; B60W 10/08; B60W 30/192; B60W 2510/0638; B60W 2510/244; B60W 2520/10; B60W 2710/086

(57) ABSTRACT

A control system for controlling a powertrain system of a hybrid vehicle includes one or more processors configured to receive a first input signal indicative of one or more operating conditions of the vehicle, wherein the one or more operating conditions include an available battery power of the electric traction motor; determine, in dependence on the first input signal, whether to reserve a first portion of a power capability of the electric traction motor for use in performing an engine start; and output a control signal to the powertrain system to withhold the first portion of the power capability from use in delivering power to a drivetrain of the vehicle in accordance with the determination, and to make available a second portion of the power capability for delivering power to the drivetrain of the vehicle.

### TECHNICAL FIELD

The present disclosure relates to controlling a powertrain system of a hybrid vehicle. Aspects of the invention relate to a control system, a system, a vehicle, a method and computer readable instructions.

### BACKGROUND

It is known for vehicles to be powered by an internal combustion engine and one or more electric traction motors (also referred to as electric motors (EM)). When a vehicle is operating such that only the electrical traction motor is being used to provide motive power, it can sometimes become necessary to initiate an engine start such that both the electric traction motor and the engine are operating. Such hybrid powertrain system are operable to perform different engine start modes depending on the environmental conditions and needs of the driver of the vehicle. As one example, the electric traction motor can be used to start the engine to provide the smoothest driving experience during the engine start, provided the electric traction motor has enough power available to start the engine.

It is an aim of the present invention to address one or more of the disadvantages associated with the prior art.

### SUMMARY OF THE INVENTION

Aspects and embodiments of the invention provide a control system, a system, a vehicle, a method and computer readable instructions as claimed in the appended claims.

This disclosure provides a technique for controlling a powertrain system of a hybrid vehicle comprising an engine and an electric traction motor. The technique determines whether to reserve a portion of the power capability provided to the electric traction motor for use in starting the engine depending on the amount of available power from a traction battery.

According to an aspect of the present invention there is provided a control system for controlling a powertrain system of a hybrid vehicle comprising an engine and an electric traction motor, the control system comprising one or more processors. The one or more processors are collectively configured to receive a first input signal indicative of one or more operating conditions of the vehicle, wherein the one or more operating conditions comprise an available battery power of the electric traction motor. The one or more processors are further configured to determine, in dependence on the first input signal, whether to withhold a first portion of a power capability of the electric traction motor for use in performing an engine start, and output a control signal to the powertrain system to withhold the first portion of the power capability from use in delivering power to a drivetrain of the vehicle in accordance with the determination, and to make available a second portion of the power capability for delivering power to the drivetrain of the vehicle.

In this way, this ensures that, when a vehicle is operating in a hybrid mode, the electric traction motor always has the enough tractive power needed to perform an engine start, provided the battery power available is high enough to perform an engine start and deliver power to the drivetrain of the vehicle.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to receive a first input signal indicative of one or more operating conditions of the vehicle, wherein the one or more operating conditions comprise an available battery power of the electric traction motor; determine, in dependence on the first input signal, whether to withhold a first portion of a power capability of the electric traction motor for use in performing an engine start; and output a control signal to the powertrain system to withhold the first portion of the power capability from use in delivering power to a drivetrain of the vehicle in accordance with the determination, and to make available a second portion of the power capability for delivering power to the drivetrain of the vehicle.

Optionally, the control system is configured to determine whether the first input signal is below or above a minimum power threshold, the first portion of the power capability being withheld from use in delivering power to the drivetrain if the first input signal is above the minimum power threshold. In this way, a portion of the power capability is only withheld if there is enough battery charge to start the engine whilst maintaining the amount of power being applied to the drivetrain, so that vehicle does not experience a noticeable loss of torque during the engine start.

Optionally, the first input signal comprises a power demand signal indicative of a power request, and the control system is configured to determine, in dependence on the power demand signal, whether to withhold a first portion of a power capability of the electric traction motor for use in performing an engine start. Optionally, the control system is configured to determine whether the power demand signal is above or below a maximum power demand threshold, the first portion of the power capability being withheld from use in delivering power to the drivetrain if the power demand signal is below the maximum power threshold.

Optionally, the control system is configured to receive a second input signal indicative of one or more vehicle operating modes, and wherein the determination is based on the first input signal and the second input signal. Optionally, the one or more vehicle operating modes comprise at least one of: an operating mode in which the use of the electric traction motor as a sole source of motive power is prioritised, a transfer box setting and a terrain mode. For example, if the second input signal indicates an operating mode in which the use of the electric traction motor as a sole source of motive power is prioritised, the first portion of power capability will not be withheld from use in delivering power to a drivetrain of the vehicle, to thereby maximise use of the available power capability of the electric traction motor for use in delivering power to the drivetrain.

Optionally, the first input signal further comprises one or more of a temperature signal indicative of a temperature of the engine, a time signal indicative of a duration of time since the engine was last operated, a vehicle speed signal indicative of a speed of the vehicle and a power demand signal indicative of a power request.

Optionally, the control system is further configured to determine a power required to start the engine based on the first input signal, and determine the first portion of power capability to be withheld based on the determined power. Optionally, the control system is further configured to determine the first portion of power capability to be withheld based on a target engine speed, wherein the control system is configured to determine the target engine speed based on the received power demand signal and vehicle speed signal. For example, the amount of power required to start the engine is determined by comparing the temperature of the engine and the target speed of the engine to a look-up table stored in the memory of the control system, and adjusting the amount of power according to a factor based on the duration of the time since the engine was last operated. In this way, the portion of power capability withheld corresponds to the amount of power needed to start the engine, to thereby maximise the amount of power capability available to the electric traction motor for use in delivering power to the drivetrain.

Optionally, the control system is further configured to receive an engine start signal from the powertrain system indicative of an engine start, and output, in response to the engine start signal, a control signal to the powertrain system to make the first portion of the power capability of the electric traction motor available for use in delivering power to the drivetrain. In this way, as soon as the engine start begins and the amount of power capability of the electric traction motor being used to start the engine begins to decrease, the amount of withheld power capability is decreased by a corresponding value until it reaches zero, such that all of the power capability of the electric traction motor is made available for delivering power to the drivetrain.

According to another aspect of the invention, there is provided a system comprising the control system as mentioned above and a powertrain system, the powertrain system comprising an engine and an electric traction motor.

According to yet another aspect of the invention, there is provided a vehicle comprising the system as mentioned above, or the control system as mentioned above.

According to a further aspect of the invention, there is provided a method for controlling a powertrain system of a hybrid vehicle comprising an engine and an electric traction motor. The method comprises receiving a first input signal indicative of one or more operating conditions of the vehicle, wherein the one or more operating conditions comprise an available battery power of the electric traction motor. The method further comprises determining, in dependence on the first input signal, whether to reserve a first portion of a power capability of the electric traction motor for use in performing an engine start, and outputting a control signal to the powertrain system to withhold the first portion of the power capability from use in delivering power to a drivetrain of the vehicle in accordance with the determination, and to make available a second portion of the power capability for delivering power to the drivetrain of the vehicle.

Optionally, the method comprises determining whether the first input signal is below or above a minimum power threshold, the first portion of the power capability being withheld from use in delivering power to the drivetrain if the first input signal is above the minimum power threshold.

Optionally, the method comprises receiving a second input signal indicative of one or more vehicle operating modes, wherein the determination is based on the first input signal and the second input signal.

Optionally, the one or more vehicle operating modes comprise at least one of an operating mode in which the use of the electric traction motor as a sole source of motive power is prioritised, a transfer box setting and a terrain mode.

According to a still further aspect of the invention, there is provided computer readable instructions which, when executed by a computer, are arranged to perform a method as mentioned above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a block diagram illustrating a control system according to an embodiment of the present invention;

FIG. 2 shows a powertrain system according to an embodiment of the present invention;

FIG. 3A shows a schematic illustration of a vehicle according to an embodiment of the present invention;

FIG. 3B shows a schematic illustration of a rear-view of the vehicle of FIG. 3A;

FIG. 4 shows a first flow chart showing operations performed by the control system of FIG. 1 according to an embodiment of the present invention;

FIG. 5 is a graph further illustrating an embodiment of the present invention

FIG. 6 shows a second flow chart showing operations performed by the control system of FIG. 1 according to an embodiment of the present invention; and

FIG. 7 shows a third flow chart showing operations performed by the control system of FIG. 1 according to an embodiment of the present invention.

### DETAILED DESCRIPTION

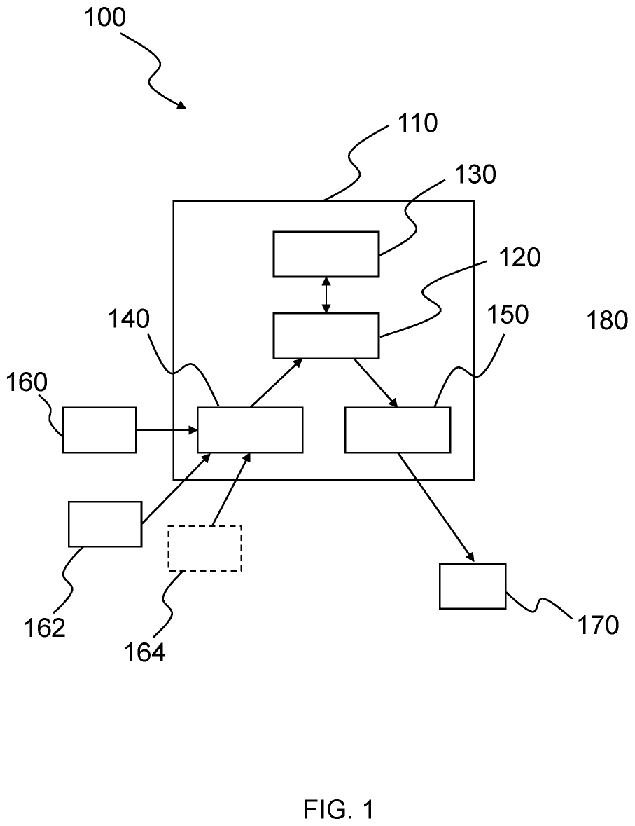

With reference to FIG. 1, there is illustrated a control system 100 for a vehicle. The control system 100 comprises one or more controller 110.

The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory devices 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 140 of the controller 110. The input 140 is arranged to receive an operating conditions signal 160 from one or more sensors indicative of one or more operating conditions of the vehicle. For example, the operating conditions signal 160 may include one or more a power demand signal indicative of the power being requested (e.g., from a driver) from a power demand sensor, a state of battery charge of the EM battery from an EM battery power sensor, an engine temperature signal indicative of a temperature of the engine from a temperature sensor, an engine operation time signal indicative of a duration of time since the engine was operated from a time sensor, and a vehicle speed signal indicative of the speed of the vehicle from a vehicle speed sensor. The operating conditions signal 160 is an electrical signal which is indicative of one or more operating conditions of the vehicle. The input 140 is also arranged to receive one or more vehicle operating mode signals 162 from one or more sensors indicative of the currently active vehicle operating modes. For example, the vehicle operating mode signal 162 may comprise one or more of an operating mode in which use of an electric traction motor (also referred to herein as an electric machine (EM) as a sole source of motive power is prioritised, a transfer box setting, and a terrain mode. The vehicle operating mode signal 162 is an electrical signal which is indicative of at least one currently active operating mode of the vehicle. Optionally, the input may be arranged to receive an engine start signal 164 from one or more sensors indicative that the engine is being operated such that both the EM and an engine are operated to deliver torque to the vehicle transmission. For example, the engine start signal 164 may comprise an engine power signal indicative that the engine is being operated to deliver torque to the transmission. The engine start signal 164 is an electrical signal which is indicative that the engine is being operated such that both the EM and an engine are operated to deliver torque to the vehicle transmission. The output 150 is arranged to output a power control signal 170 requesting that a first portion of EM power capability is withheld from use in delivering power to the transmission of the vehicle, and that a second portion of EM power capability is made available for use in delivering power to the transmission of the vehicle, as will be described in further detail below.

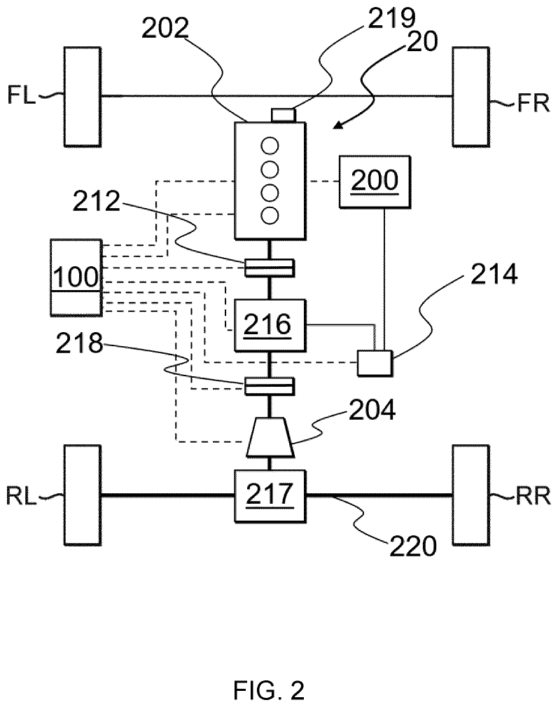

FIG. 2 illustrates an example system 20 for a parallel hybrid electric vehicle (HEV). The system 20 defines, at least in part, a powertrain of the HEV. The system 20 comprises the control system 100, as explained with reference to FIG. 1. The control system 100 may comprise one or more of: a hybrid powertrain control module; an engine control unit; a transmission control unit; a traction battery management system; and/or the like. The system 20 comprises an engine 202. The engine 202 may be a combustion engine. The illustrated engine 202 is an internal combustion engine. The illustrated engine 202 comprises four combustion chambers, however a different number of combustion chambers may be provided in other examples.

The engine 202 is operably coupled to the control system 100 to enable the control system 100 to control output torque of the engine 202. The output torque of the engine 202 may be controlled by controlling one or more of: air-fuel ratio; spark timing; poppet valve lift; poppet valve timing; throttle opening position; fuel pressure; turbocharger boost pressure; and/or the like, depending on the type of engine 202.

The system 20 further comprises an electric traction motor 216. In some embodiments, the system 20 has one electric traction motor. In other embodiments, the system 20 has more than one electric traction motor. The first electric traction motor 216 may be an alternating current induction motor or a permanent magnet motor, or another type of motor. The electric traction motor is also referred to herein as an electric machine (EM). The electric traction motor 216 may be a crankshaft integrated motor generator (CIMG). The electric traction motor 216 is configured to apply positive or negative torque to the crankshaft or to an output shaft connected to the crankshaft, for example to provide functions such as: boosting output torque of the engine 202; deactivating (shutting off) the engine 202 while at a stop or coasting; activating (starting) the engine 202; and regenerative braking in a regeneration mode. In a hybrid electric vehicle mode, the engine 202 and electric traction motor 216 may both be operable to supply positive torque simultaneously to boost output torque. The electric traction motor 216 may be capable of electric only driving.

The system 20 comprises a vehicle transmission arrangement 204 for receiving output torque from the engine 202 and/or from the electric traction motor 216. The vehicle transmission arrangement 204 may comprise an automatic vehicle transmission, a semi-automatic vehicle transmission, or a manual vehicle transmission.

The engine 202 is mechanically connected or connectable to the electric traction motor 216 via a first torque path connector in the form of a first clutch 212. The electric traction motor 216 is mechanically connected or connectable to the transmission 204 via a second torque path connector in the form of a second clutch 218. The second clutch 218 is illustrated in FIG. 2 as a single clutch located along the drive shaft between the electric traction motor 216 and the transmission 204. In other embodiments, the second clutch 218 could be integrated with the electric traction motor 216 and/or with the transmission 204. In the latter example, the second clutch could be a core clutch used for gear shifts. The function of the second clutch could be provided by a single clutch, as illustrated, or a by plurality of clutches which are each configured to connect the electric traction motor 216 to the transmission 204 and thereby fulfil the function of the second clutch. For example, the second clutch could comprise a clutch which is operable to connect the electric traction motor 216 to the transmission 204 when the transmission is in one of a first set of gears (e.g., gears 1-4) and one or more further clutches which are operable to connect the electric traction motor 216 to the transmission 204 when the transmission is in one of a second set of gears (e.g., gears 5-8). The electric traction motor 216 is mechanically connected or connectable to a first set of vehicle wheels (RL, RR) via a torque path which extends from an output of the electric traction motor 216 to the second clutch 218 then to the transmission 204, then to the axle/driveshafts 220, and then to the first set of vehicle wheels (RL, RR). The engine 202 is mechanically connected or connectable to the first set of vehicle wheels (RL, RR) via a torque path which extends from an output of the engine 202, then to the first clutch 212, then to the electric traction motor 216, then to the second clutch 218, then to the transmission 204, then to the axle/driveshafts 220, and then to the first set of vehicle wheels (RL, RR). One or both of the engine 202 and the electric traction motor 216 are able to provide torque to a first axle 220 of the vehicle. However, when the torque path between the electric traction motor 216 and the first set of vehicle wheels (RL, RR) is disconnected, the torque path 220 between engine 202 and the first set of vehicle wheels (RL, RR) is also disconnected. In a vehicle overrun and/or friction braking situation, torque may flow from the first set of vehicle wheels (RL, RR) to the electric traction motor 216 and optionally to the engine 202. Torque flow towards the first set of vehicle wheels (RL, RR) is positive torque, and torque flow from the first set of vehicle wheels (RL, RR) is negative torque. The illustrated first set of vehicle wheels (RL, RR) comprises rear wheels. Therefore, the illustrated system 20 is configured for rear wheel drive. In another example, the first set of vehicle wheels may be front wheels (FL, FR). The illustrated front wheels (FL, FR) is a pair of vehicle wheels, however a different number of vehicle wheels could be provided in other examples.

The system 20 may comprise a differential 217 for receiving output torque from the transmission 204, i.e. from the gear train. The differential may be integrated into the vehicle transmission arrangement 204 as a transaxle, or provided separately. In this respect, it will be understood that one or more of the transmission 204, differential 217 and torque path 220 may be collectively referred to as the drivetrain of the vehicle.

The illustrated system 20 comprises one electric traction motor 216. In other embodiments, the system 20 may have more than one electric traction motor. The system (20) may further comprise a starter motor 219 which is mechanically connected or connectable to the engine 202. For example, the starter motor 219 may be a belt integrated starter generator (BISG) or a pinion starter motor. In the illustration, the starter motor 219 is located at an accessory drive end of the engine 202, opposite a vehicle transmission end of the engine 202.

The control system 100 may be configured to disconnect the torque path between the engine 202 and the first set of vehicle wheels (RL, RR) in electric vehicle mode, for example to reduce parasitic pumping energy losses or to operate in an electric vehicle mode. For example, the first clutch 212 may be opened.

In some embodiments, the vehicle comprises another motive power source, or prime mover, arranged to provide torque to at least one wheel (FL, FR) of another axle of the vehicle. For example, the system (20) may further comprise a second electric traction motor (not shown) or a second internal combustion engine (not shown), either of which may provide positive torque alone or in combination with the electric traction motor 216 and/or the engine 202.

In order to store electrical power for the electric traction motor 216, the system 20 comprises a traction battery 200. The traction battery 200 provides a nominal voltage required by electrical power users such as the electric traction motor.

The traction battery 200 may be a high voltage (HV) battery. High voltage traction batteries provide nominal voltages in the hundreds of volts, as opposed to traction batteries for mild HEVs which provide nominal voltages in the tens of volts. The traction battery 200 may have a voltage and capacity to support electric only driving for sustained distances. The traction battery 200 may have a capacity of several kilowatt-hours, to maximise range. The capacity may be in the tens of kilowatt-hours, or in the hundreds of kilowatt-hours.

Although the traction battery 200 is illustrated as one entity, the function of the traction battery 200 could be implemented using a plurality of small traction batteries in different locations on the vehicle.

The system 20 may comprises one or more inverters 214. One inverter 214 is shown, for the electric traction motor 216. In other examples, two or more inverters could be provided.

It can be appreciated from the foregoing that the vehicle may be provided with motive torque from a combination of sources.

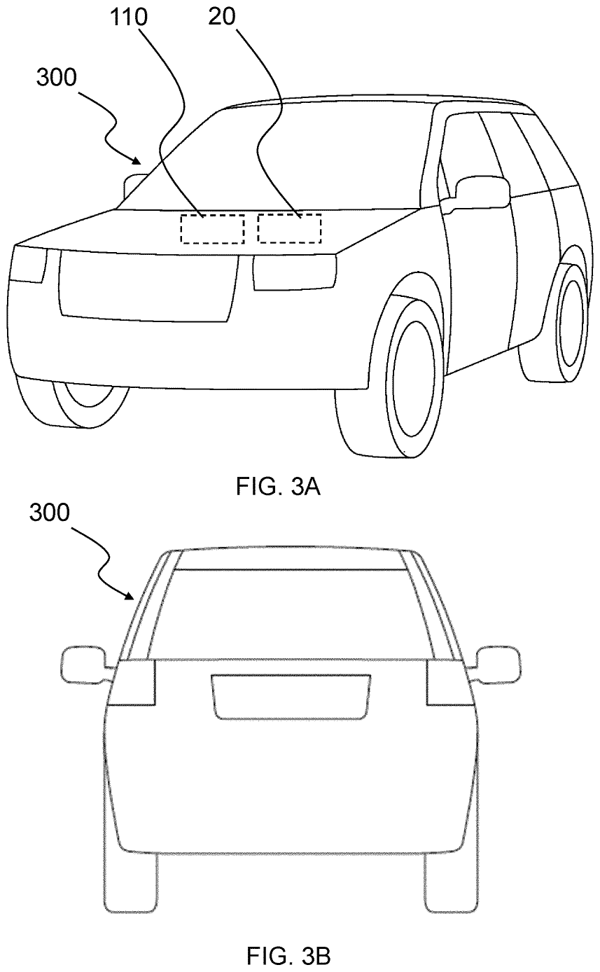

FIGS. 3A-B illustrate a vehicle 300 according to an embodiment of the present invention. The vehicle 300 comprises a control system 100 as illustrated in FIG. 1. The controller 110 is shown as mounted within the vehicle 300 and is in communication with the powertrain 20. The powertrain 20 is a hybrid powertrain system of the vehicle 300. The powertrain 20 comprises an engine 202 and an EM 216. FIG. 3B illustrates a rear-view of the vehicle 300 of FIG. 3A.

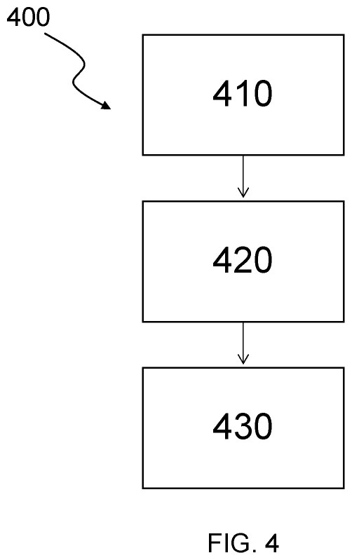

FIG. 4 illustrates a method 400 according to an embodiment of the invention. The method 400 is a method of controlling a hybrid powertrain system 20 of a vehicle 300, such as the vehicle 300 illustrated in FIGS. 3A and 3B. The hybrid powertrain system 20 comprises an engine 202 (an internal combustion engine which may be powered by petrol, diesel, hydrogen, an e-fuel, for example, or any suitable combustible fuel) and an electric traction motor 216, and is operable to deliver torque to the transmission 204 of the vehicle using one or both of the engine 202 and the electric traction motor 216. The method 400 may be performed by the control system 100 illustrated in FIG. 1. In particular, the memory 130 may comprise computer-readable instructions which, when executed by the processor 120, perform the method 400 according to an embodiment of the invention.

When the vehicle 300 is operating such that only the electrical traction motor 216 is supplying output torque to the transmission 204, it can sometimes become necessary to initiate an engine start such that both the electric traction motor 216 and the engine 202 are operating to supply output torque. An engine start may be required for a variety of reasons, for example, an increase in power demand that requires a torque output that exceeds the power capability of the electric traction motor 216. The hybrid powertrain system 20 is operable to start the engine 202 using a number of different engine start modes, but will seek to utilise the start mode that will maintain performance and provide the smoothest driving experience.

For example, the engine start modes may include a comfort slip start mode or a response slip start mode.

A comfort slip start mode occurs when the first clutch 212 between the electric traction motor 216 and the engine 202 is partially engaged to start the engine while the second clutch 218 between the electric traction motor and the transmission 204 of the vehicle is also partially engaged, with the first and second clutches being fully engaged only once the engine speed is matched to the electric traction motor speed. This mode allows the vehicle to smoothly switch from using the electric traction motor only to using the engine either alone or in combination with the electric traction motor, by transferring torque from the electric traction motor to the engine via the first clutch to get the engine running prior to the switch. By slipping (i.e., partially engaging) the second clutch, oscillations or torque spikes which can occur due to the transfer of torque are damped, thus providing a smoother driver experience. In the following discussion, the comfort slip start mode is referred to simply as a slip start mode, since this is the normal type of slip start operation.

A response slip start mode occurs when the first clutch between the electric traction motor and the engine is partially engaged to start the engine and is fully engaged once the engine speed is matched to the electric traction motor speed, while the second clutch between the electric traction motor and the transmission remains fully engaged throughout. This differs from the comfort slip start mode above in that the second clutch is not slipped (i.e., the second clutch remains fully engaged). This mode can be used, for example, when driver demand is high, i.e., rapid acceleration is desired. This mode provides a faster vehicle response, but can mean that the ride is less smooth. In comfort slip start modes, oscillations can be less noticeable because the slipped clutch connecting the EM to the gearbox/wheels dampens the oscillations. This means the driver does not feel the oscillations as much. It can be important to have a fast controller in slip start modes because overshooting the engine/EM speed can have negative consequences on the NVH characteristics of the vehicle. Fast controllers have less overshoot than slow controllers.

To perform a slip start, the electric traction motor 216 must have enough power capability to start the engine 202 whilst still maintaining the amount of torque being applied to the transmission 204, so that the vehicle 300 does not experience a noticeable loss of torque during the engine start.

At step 410, the control system 100 is configured to receive an operating conditions signal 160 indicative of the state of battery charge of the traction battery 200 for the electric traction motor 216. Optionally, this operating conditions signal 160 is produced by the controller based on receiving data relating to the state of the battery charge of the traction battery 200 for the electric traction motor 216 from an EM battery power sensor. Optionally, the operating conditions signal 160 may comprise a power demand signal indicative of a power being requested (e.g., by the driver). Optionally, at step 410, the control system 100 may also be configured to receive a vehicle operating mode signal 162 indicating one or more operating modes of the vehicle 300. Optionally, this vehicle operating mode signal 162 is produced by the controller 110 based on receiving data relating to an operating mode in which use of an electric traction motor 216 as a sole source of motive power is prioritised, a transfer box setting, and a terrain mode. For example, the data relating to the operating mode in which use of an electric traction motor 216 as a sole source of motive power is prioritised and the terrain mode may be received in response to a user input via a human-machine interface (HMI) of the vehicle 300. As another example, the data relating to the transfer box setting may be received in response to a user input via a gear selector.

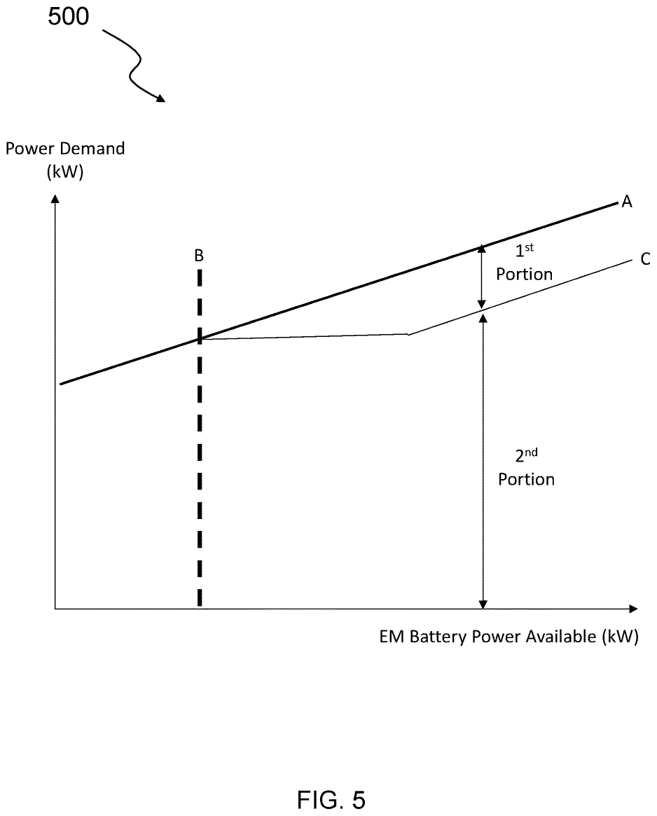

At step 420, the control system 100 is configured to determine whether to reserve a first portion of the power capability of the electric traction motor 216 for use in performing an engine start in dependence on the state of battery charge of the traction battery 200. Optionally, as illustrated by the graph 500 shown in FIG. 5, the control system 100 may determine that a first portion of the available power capability of the electric traction motor 216 (as denoted by line “A”) should be reserved for use in performing an engine start if the battery charge of the traction battery 200 is above a minimum power threshold (as denoted by line “B”). In this respect, it will be appreciated that the minimum power threshold B is a calibratable value that will depend on the power capability of the vehicle 300. As such, if the traction battery 200 has enough battery charge to power the electric traction motor 216 to deliver torque to the transmission 204 and to start the engine 202, a first portion of the available power capability (i.e., the region between the available power capability A and the line denoted “C”) will be reserved for use in performing the engine start, and a second portion of the available power capability (i.e., the region under line “C”) will be made available for use in delivering power to the transmission 204 (i.e., to the drivetrain). If the battery charge of the traction battery 200 is below the minimum power threshold B, then a first portion of the available power capability will not be reserved for use in performing an engine start, in which case other methods of performing an engine start (e.g., using the starter motor 219) may be required. Optionally, the available power capability A of the electric traction motor 216 may correspond to its maximum power capability.

Optionally, at step 420, the control system 100 may be configured to determine whether to reserve a first portion of the power capability of the electric traction motor 216 for use in performing an engine start in dependence on the state of battery charge of the traction battery 200, along with one or more of a power demand signal indicative of the power being requested and one or more operating modes of the vehicle 300. In this respect, if the state of battery charge of the traction battery 200 is above the minimum power threshold B, one or more of the power demand signal and one or more operating modes of the vehicle 300 may be used to further determine whether to reserve a first portion of the power capability of the electric traction motor 216 for use in performing an engine start. For example, if the power demand signal indicates an increasing power demand such that the power being demanded is close to an upper limit of the available power capability A (e.g., the power being demanded is in the region between lines “A” and “C” shown in FIG. 5), the control system 100 may be configured to determine that a first portion of the power capability of the electric traction motor 216 should not be reserved for use in performing an engine start as the electric traction motor 216 will not have enough power available to perform an engine start and continue to deliver the power being demanded. If the power demand signal indicates a power demand below a maximum power demand threshold (as denoted by line “C”), the control system 100 may be configured to determine that a first portion of the power capability of the electric traction motor 216 can be reserved for use in performing an engine start. In this respect, it will be appreciated that the maximum power demand threshold C is a calibratable value that will depend on the power capability of the vehicle 300 and the amount of power needed to start the engine 202, as described further below. As a further example, if the vehicle operating mode signal 162 indicates an operating mode in which use of an electric traction motor 216 as a sole source of motive power is prioritised, the control system 100 may be configured to determine that a first portion of the power capability of the electric traction motor 216 should not be reserved for use in performing an engine start to thereby maximise use of the available power capability of the electric traction motor 216 for use in delivering torque to the transmission 204. In such cases, should an engine start be required (e.g., due to a power demand by the driver that exceeds the maximum power capability of the electric traction motor 216), other methods of performing the engine start (e.g., using the starter motor 219) will be prioritised. As another example, the vehicle operating mode signal 162 may be indicative of a transfer box setting of the vehicle, which may be indicative that the vehicle is operating in a low range setting (i.e., using low range gears typically used in “off-road” settings where vehicle is operating at lower speeds) or a high range setting (i.e., using high range gears typically used for “on-road” settings where vehicle is operating at higher speeds). If the vehicle operating mode signal 162 is indicative of a low range setting, the control system 100 may be configured to determine that a first portion of the power capability of the electric traction motor 216 should not be reserved for use in performing an engine start to thereby maximise use of the available power capability of the electric traction motor 216 for use in delivering torque to the transmission 204, which may be required for operating the vehicle 300 over difficult terrain. If the vehicle operating mode signal 162 is indicative of a high range setting, the control system 100 may be configured to determine that a first portion of the power capability of the electric traction motor 216 can be reserved for use in performing an engine start. As a further example, the vehicle operating mode signal 162 may be indicative of a terrain mode of the vehicle 300, which is indicative of the terrain on which the vehicle 300 is operating, for example, normal terrain (e.g., road), snowy terrain, sandy terrain, rocky terrain, or muddy terrain. If the vehicle operating mode signal 162 is indicative of a terrain such as normal or snowy terrain that require less power capability, the control system 100 may be configured to determine that a first portion of the power capability of the electric traction motor 216 can be reserved for use in performing an engine start. If the vehicle operating mode signal 162 is indicative of a terrain such as sandy, rocky or muddy terrain, the control system 100 may be configured to determine that a first portion of the power capability of the electric traction motor 216 should not be reserved for use in performing an engine start to thereby maximise use of the available power capability of the electric traction motor 216 for use in delivering torque to the transmission 204.

Once the control system 100 has determined whether to reserve a first portion of the power capability of the electric traction motor 216 for use in performing an engine start, the control system 100 is configured to output, at step 430, a control signal 170 to cause the powertrain system 20 to withhold the first portion of the power capability for use in performing an engine start in accordance with the determination, and to make available a second portion of the power capability of the electric traction motor 216 for delivering power to the transmission 204. This ensures that, when the vehicle 300 is operating in a hybrid electric vehicle mode, the electric traction motor 216 has enough tractive power to perform a slip start, if the power demand is such that an engine start is required. Optionally, if it is determined that no portion of the power capability is to be reserved for use in performing an engine start, the second portion of the power capability available for delivering power to the transmission 204 will be the maximum power capability A of the electric traction motor 216.

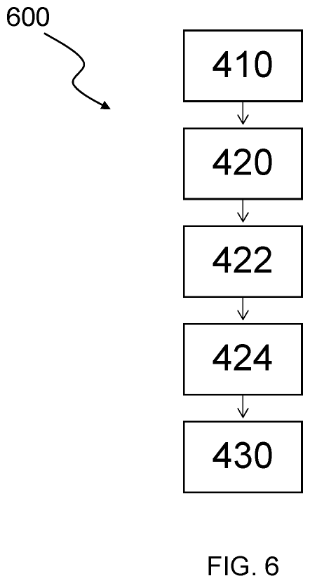

FIG. 6 is a flowchart 600 according to an embodiment of the invention. The flow chart 600 illustrates a method of controlling a hybrid powertrain system 20 of a vehicle 300, such as the vehicle 300 illustrated in FIGS. 3A and 3B. Steps 410, 420 and 430 are the same as that illustrated in FIG. 4 and their discussion is not repeated in detail for brevity. However, compared to FIG. 4, the flow chart 400 of FIG. 6 contains a further step 422 at which the control system 100 is configured to determine the power required to start the engine 202 and step 424 at which the control system 100 is configured to determine the first portion of power capability to be withheld. In this respect, the operating conditions signal 160 may comprise one or more of a temperature signal indicative of a temperature of the engine 202, an engine operation time signal indicative of a duration of time since the engine was operated, a power demand signal indicative of a power being requested, and a vehicle speed signal indicative of the speed of the vehicle 300. Optionally, at step 422, the control system 100 is configured to determine the power required to start the engine 202 based on one or more of the temperature of the engine 202, the target speed of the engine 202, and the duration of the time since the engine 202 was last operated, the first portion of power capability to be withheld being determined at step 424 based on this determined power. Optionally, the amount of power required to start the engine 202 is determined by comparing the temperature of the engine 202 and the target speed of the engine 202 to a look-up table stored in the memory 130 of the control system 100, and adjusting the amount of power according to a factor based on the duration of the time since the engine 202 was last operated. Optionally, the control system 100 is configured to determine the target speed of the engine 202 based on the power being demanded and the speed of the vehicle 300. In this respect, the speed of the engine 202 will need to match the speed of the electric traction motor 216, which depends on the speed of the vehicle 300 and the power being demanded. As such, the target engine speed will correspond to the speed of the electric traction motor 216 with any required upshift in gear to thereby maintain the speed of the vehicle 300 and any expected vehicle acceleration as power is demanded. The determined first portion of power capability to be withheld may then be output as the control signal 170, at step 430, to cause the powertrain system 20 to withhold the determined first portion of the power capability for use in performing an engine start.

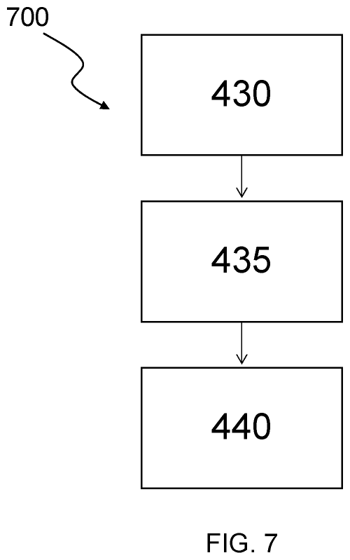

FIG. 7 is a flowchart 700 according to an embodiment of the invention. The flow chart 700 illustrates a method of controlling a hybrid powertrain system 20 of a vehicle 300, such as the vehicle 300 illustrated in FIGS. 3A and 3B. Step 430 is the same as that illustrated in FIG. 4 and its discussion is not repeated in detail for brevity.

At step 435, the control system 100 is configured to receive an engine start signal 164 indicating that an engine start has been initiated. Optionally, this engine start signal 164 is produced by the controller 110 based on receiving data relating to an engine power signal indicative that the engine 202 has begun operating to deliver torque to the transmission. In response to the engine start signal 164, the control system 100 is configured, at step 440, to output a control signal 170 to the powertrain system 20 to make the first portion of the power capability of the electric traction motor 216 available for use in delivering power to the transmission 204, to thereby maximise use of the available power capability of the electric traction motor 216 for use in delivering torque to the transmission 204. In this way, once an engine start has begun and both the engine 202 and electric traction motor 216 are being operated to provide torque to the transmission 204, all of the power capability of the electric traction motor 216 is made available for delivering torque to the transmission 204. In this respect, as soon as the amount of power capability of the electric traction motor 216 being used to start the engine 202 begins to decrease, the first portion of power capability reserved for performing an engine start is decreased by a corresponding value until it reaches zero, such that all of the power capability of the electric traction motor 216 is made available for delivering torque to the transmission 204.

It will be appreciated that various changes and modifications can be made to the present invention without departing from the scope of the present application.

1. A control system for controlling a powertrain system of a hybrid vehicle comprising an engine and an electric traction motor, the control system comprising one or more processors, the one or more processors collectively configured to:
receive a first input signal indicative of one or more operating conditions of the vehicle, wherein the one or more operating conditions comprise an available battery power of the electric traction motor;
determine, in dependence on the first input signal, whether to withhold a first portion of a power capability of the electric traction motor for use in performing an engine start; and
output a control signal to the powertrain system to withhold the first portion of the power capability from use in delivering power to a drivetrain of the vehicle in accordance with the determination, and to make available a second portion of the power capability for delivering power to the drivetrain of the vehicle.

2. The control system of claim 1, wherein the control system is configured to determine whether the first input signal is below or above a minimum power threshold, the first portion of the power capability being withheld from use in delivering power to the drivetrain if the first input signal is above the minimum power threshold.

3. The control system of claim 1, wherein the control system is configured to receive a second input signal indicative of one or more vehicle operating modes, and wherein the determination is based on the first input signal and the second input signal.

4. The control system of claim 3, wherein the one or more vehicle operating modes comprise at least one of an operating mode in which the use of the electric traction motor as a sole source of motive power is prioritised, a transfer box setting and a terrain mode.

5. The control system of claim 1, wherein the first input signal further comprises one or more of a temperature signal indicative of a temperature of the engine, a time signal indicative of a duration of time since the engine was last operated, a vehicle speed signal indicative of a speed of the vehicle, and a power demand signal indicative of a power request.

6. The control system of claim 5, wherein the control system is further configured to:
determine a power required to start the engine based on the first input signal; and
determine the first portion of power capability to be withheld based on the determined power.

7. The control system of claim 6, wherein the control system is further configured to determine the first portion of power capability to be withheld based on a target engine speed, wherein the control system is configured to determine the target engine speed based on the received power demand signal and vehicle speed signal.

8. The control system of claim 1, wherein the control system is further configured to:
receive an engine start signal from the powertrain system indicative of an engine start; and
output, in response to the engine start signal, a control signal to the powertrain system to make the first portion of the power capability of the electric traction motor available for use in delivering power to the drivetrain.

9. A system comprising the control system of claim 1 and a powertrain system, the powertrain system comprising an engine and an electric traction motor.

10. A vehicle comprising the control system of claim 1.

11. A method for controlling a powertrain system of a hybrid vehicle comprising an engine and an electric traction motor, the method comprising:
receiving a first input signal indicative of one or more operating conditions of the vehicle, wherein the one or more operating conditions comprise an available battery power of the electric traction motor;
determining, in dependence on the first input signal, whether to withhold a first portion of a power capability of the electric traction motor for use in performing an engine start; and
outputting a control signal to the powertrain system to withhold the first portion of the power capability from use in delivering power to a drivetrain of the vehicle in accordance with the determination, and to make available a second portion of the power capability for delivering power to the drivetrain of the vehicle.

12. The method of claim 11, wherein the method comprises determining whether the first input signal is below or above a minimum power threshold, the first portion of the power capability being withheld from use in delivering power to the drivetrain if the first input signal is above the minimum power threshold.

13. The method of claim 11, wherein the method comprises receiving a second input signal indicative of one or more vehicle operating modes, wherein the determination is based on the first input signal and the second input signal.

14. The method of claim 13, wherein the one or more vehicle operating modes comprise at least one of an operating mode in which the use of the electric traction motor as a sole source of motive power is prioritised, a transfer box setting and a terrain mode.

15. Computer readable instructions which, when executed by a computer, are arranged to perform the method according to claim 11.
